(19) United States
(12) Patent Application Publication
(10) Pub. No.: US 2026/0186804 A1
(43) Pub. Date: Jul. 2, 2026

(54) INFORMATION PROCESSING APPARATUS, CONTROL METHOD, AND STORAGE MEDIUM

(71) Applicant: Canon Kabushiki Kaisha, Tokyo (JP)

(72) Inventor: Keisuke Mizutani, Kanagawa (JP)

(21) Appl. No.: 19/544,029

(22) Filed: Feb. 19, 2026

Related U.S. Application Data
(63) Continuation of application No. 17/969,031, filed on Oct. 19, 2022.

(30) Foreign Application Priority Data
Oct. 29, 2021 (JP) 2021-177389

(51) Int. Cl. G06F 9/451; G06F 3/0481; G06F 3/0486

(52) U.S. Cl. CPC G06F 9/451; G06F 3/0481; G06F 3/0486

(57) ABSTRACT

A method of controlling an information processing apparatus executing an application includes, in a case where being in a multi-window mode is detected, displaying, in a display window of the application, an object acceptance area capable of accepting a sharing operation of an object from a different application and in a case where the object is accepted by the sharing operation in the object acceptance area, executing a predetermined process using the object.

### CROSS-REFERENCE TO RELATED APPLICATION

This application is a Continuation of U.S. patent application Ser. No. 17/969,031, filed Oct. 19, 2022.

### BACKGROUND OF THE INVENTION

### Field of the Invention

The present disclosure relates to a technique of information processing using a plurality of windows.

### Description of the Related Art

As a mobile information processing apparatus such as a PC, a tablet terminal, or a smartphone, there is an apparatus with a multi-window mode in which a plurality of application are simultaneously activated to display a window for each application on one screen. For example, in an information processing apparatus having a small screen such as a smartphone, by performing an operation to divide a screen after activating a plurality of applications, the plurality of applications can be displayed by screen division (see Japanese Patent Laid-Open No. 2015-125567). Further, some information processing apparatuses have the function of sharing a file between applications by an operation such as drag-and-drop between a plurality of windows displayed in one screen in a multi-window mode.

There is a need for a technique that allows a user to easily perceive that an object can be shared between applications in a multi-window mode and allows the user to easily execute sharing.

### SUMMARY OF THE INVENTION

A program according to one aspect of the present disclosure is an application program executed in an information processing apparatus, the program causing a computer which is the information processing apparatus to function as a display control unit configured to, in a case where being in a multi-window mode is detected, display, in a display window of the application, an object acceptance area capable of accepting a sharing operation of an object from a different application and an executing unit configured to, in a case where the object is accepted by the sharing operation in the object acceptance area, execute a predetermined process using the object.

Further features of the present invention will become apparent from the following description of exemplary embodiments with reference to the attached drawings.

### BRIEF DESCRIPTION OF THE DRAWINGS

FIGS. 1A and 1B are diagrams showing an external view of an information processing apparatus;

FIGS. 2A and 2B are diagrams showing a configuration of the information processing apparatus;

FIGS. 3A and 3B are diagrams showing an example of a multi-window mode;

FIGS. 4A and 4B are diagrams showing an example of a screen in the multi-window mode;

FIG. 5 is a flowchart showing an example of processing in a second application;

FIG. 6 is a diagram showing an example of a document preview screen;

FIG. 7 is a flowchart showing an example of processing in the second application;

FIG. 8 is a diagram showing an example of a confirmation screen;

FIG. 9 is a flowchart showing an example of processing in the second application; and

FIG. 10 is a diagram showing an example of the screen showing unacceptable information.

### DESCRIPTION OF THE EMBODIMENTS

A preferable embodiment of the present disclosure will be described in detail below with reference to the accompanying drawings. It should be noted that the following embodiments do not limit the present disclosed matters, and not all combinations of features described in the present embodiments are essential to a solution in the present disclosure. The same reference number is assigned to the same component, and the description thereof will be omitted.

### First Embodiment

### External View of an Information Processing Apparatus

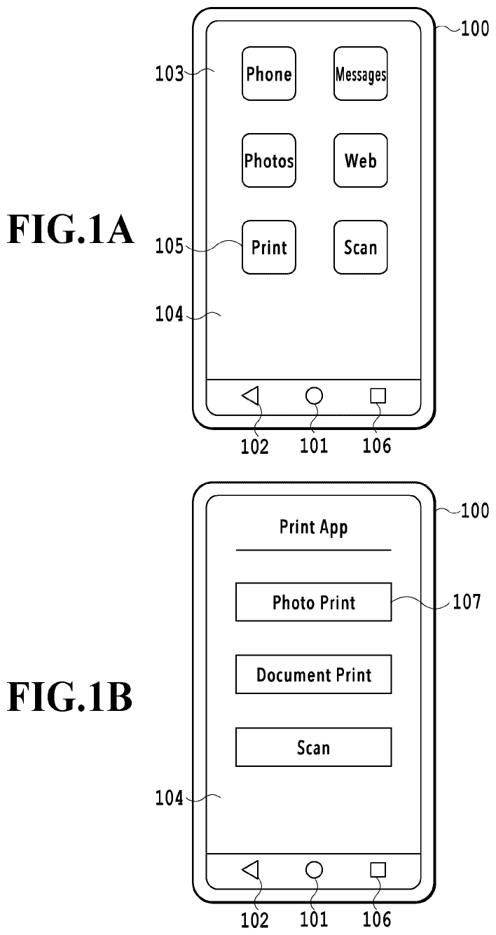

FIGS. 1A and 1B are external views of an information processing apparatus 100. It is only required that the information processing apparatus 100 be any device including a display unit such as a personal information terminal such as a PDA (Personal Digital Assistant), a smartphone, or a tablet. In the present embodiment, a smartphone is used as an example of the information processing apparatus. A smartphone is a multifunctional mobile phone equipped with a camera function, an Internet browser function, a mail function, and the like in addition to a mobile phone function. Various application programs (hereinafter referred to as applications or apps) are installed in the smartphone.

FIG. 1A shows an example in which a screen of a list of applications installed in the information processing apparatus 100 is displayed on a display unit 103 of the information processing apparatus 100. Each application is displayed in the form of an icon 105. In a case where a user taps the icon 105, a corresponding application is activated. The information processing apparatus 100 includes a home button 101. Pressing the home button 101 can close a screen of the running application and return to a screen in which a list of applications is displayed (the screen in FIG. 1A). The information processing apparatus 100 also includes a back button 102. Pressing the back button 102 can change to a previous screen used most recently by the user. Repeatedly pressing the back button 102 can display screens most recently used by the user in reverse chronological order of use.

The display unit 103 is a display with an LCD (Liquid Crystal Display) type display mechanism. The display of the display unit 103 is not limited to the LCD type but may be, for example, an organic EL display (OELD: Organic Electro-Luminescence Display), an inorganic EL display (IELD: Inorganic Electro-Luminescence Display), or any other type.

An operation unit 104 has a touch panel type operation mechanism to detect a user's pressing operation. The operation unit 104 detects contact of a finger, a pen, or the like with the display unit 103. The operation unit 104 can also detect a location where a plurality of fingers, pens, or the like contact the display unit 103. The method of detecting the operation unit 104 may be any method such as a capacitance method, a resistance film method, a surface acoustic wave method (or an ultrasonic method), an infrared method, an electromagnetic induction method, or a load detection method. To facilitate description, it is assumed below that a user contacts the operation unit 104 with a finger to operate the smartphone. The information processing apparatus 100 determines the type of gesture based on at least one of contact detected by the operation unit 104, a location where the contact is detected, a change in the location where the contact is detected, an interval at which the contact is detected, and the number of times the contact is detected. A gesture means an operation performed on the operation unit 104.

Gestures determined by the information processing apparatus 100 include, but are not limited to, a touch, release, swipe, drag, and flick, for example. “Touch” is a gesture in which a finger touches the operation unit 104. The information processing apparatus 100 determines a gesture in which a finger touches the operation unit 104 as a touch. Pressing the various buttons described above is synonymous with touching a button icon. “Release” is a gesture in which a finger moves off the operation unit 104. The information processing apparatus 100 determines the gesture in which a finger moves off the operation unit 104 as a release. “Swipe” is a gesture in which a finger moves while being in contact with the operation unit 104. The information processing apparatus 100 determines the gesture in which a finger moves while being in contact with the operation unit 104 as a swipe. “Flick” is a gesture in which a finger touches the operation unit 104 and then moves away from the operation unit 104. That is, “flick” is the gesture in which a release is performed while the finger moves following the touch. The information processing apparatus 100 determines as a flick a gesture in which a finger touches the operation unit 104 and then moves away from the operation unit 104. The flick is often performed with a finger moving in one direction. The flick includes “up flick” in which a finger moves up on the screen, “down flick” in which a finger moves down the screen, “right flick” in which a finger moves right on the screen, “left flick” in which a finger moves to the left on the screen, and the like. The finger movement accompanying the flick is often faster than the finger movement accompanying the swipe. “Drag” is used in combination with “release.” The drag is an operation similar to the flick, except that the drag is used as an operation of moving an object such as an icon displayed on the display unit 103. The operation of moving an object is often referred to as “drag-and-drop.”

The information processing apparatus 100 performs an operation in accordance with these gestures determined via the operation unit 104. Therefore, intuitive operability for a user is realized. The operation performed by the information processing apparatus 100 in accordance with a determined gesture may differ depending on a screen displayed in the display unit 103. As described above, Graphical User Interface (GUI) parts such as the application icon 105, the home button 101, and the back button 102 are displayed in the display unit 103 of the information processing apparatus 100. The user can use a function indicated by a GUI part by operating the GUI part. In the present embodiment, these navigation buttons, the home button 101 and the back button 102, are button-shaped GUI displays in the display unit 103 but are not limited to them, and may be physical buttons provided in the information processing apparatus 100. The information processing apparatus 100 also includes a history button 106, and in a case where the history button 106 is touched, the history of recently used applications is displayed in the display unit 103.

FIG. 1B shows a screen in a state where one of the listed and displayed applications is being used. The screen of the application in use is displayed on the information processing apparatus 100, and by tapping a button indicating each function as represented by the button 107, the function can be used. FIG. 1B shows a diagram showing a state where a print application is activated in the information processing apparatus 100.

### Configuration of the Information Processing Apparatus

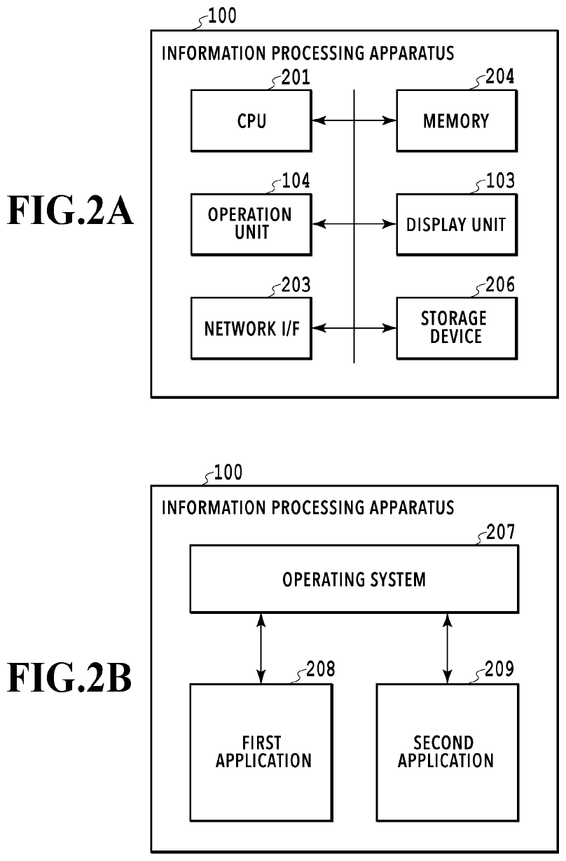

FIGS. 2A and 2B are diagrams showing the configuration of the information processing apparatus 100. FIG. 2A shows an example of a hardware configuration of the information processing apparatus 100. The information processing apparatus 100 includes a CPU 201, a memory 204, an operation unit 104, a display unit 103, a network interface 203, and a storage device 206. The CPU 201 controls the entire information processing apparatus 100. The operation unit 104 is used by the user to give an instruction to the information processing apparatus 100. The network interface 203 is an interface connecting the information processing apparatus 100 to a network. The network interface 203 is connected to the network and connects the information processing apparatus 100 to an external device such as a printer or the Internet via the network. As described above, the display unit 103 is a display mechanism such as a liquid crystal panel. The storage device 206 is a storage device such as a flash memory. The storage device 206 stores various control programs such as an application and an operating system. The memory 204 is a random access memory (RAM) as a work area for the CPU 201.

FIG. 2B shows an example of a software configuration of the information processing apparatus 100. The information processing apparatus 100 includes an operating system (hereinafter referred to as an OS) 207, a first application 208, and a second application 209. FIG. 1B shows two applications for the sake of brief description, but the present disclosure is not limited to the example. Three or more applications may be provided. The first application 208 and the second application 209 operate via the OS 207. These software programs are stored in the storage device 206, expanded in the memory 204, and executed by the CPU 201.

### Multi-Window Mode

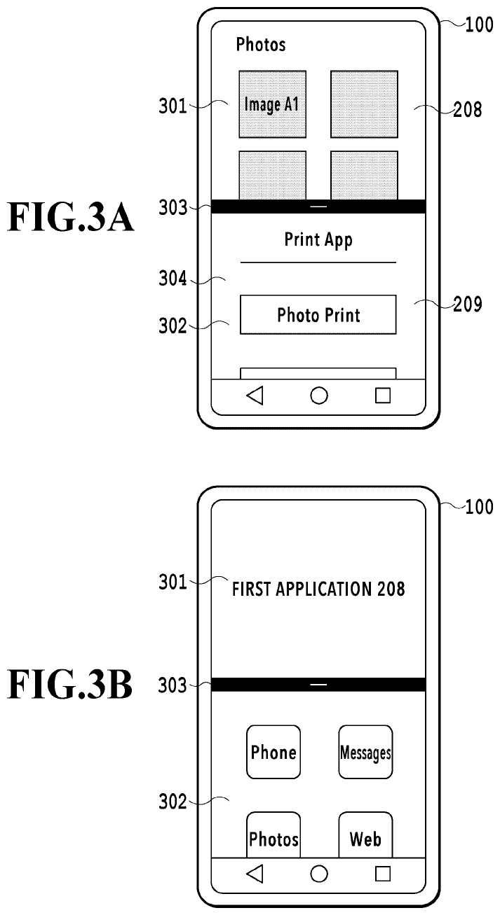

FIGS. 3A and 3B are diagrams showing an example of a multi-window mode provided in the information processing apparatus 100. The multi-window mode is implemented by the control of the OS 207. FIG. 3A shows a screen in a state where two applications are displayed in the multi-window mode. FIG. 3A shows an example in which a photograph application is activated in an upper portion of the screen as the first application 208 and the print application is activated in a lower portion of the screen as the second application 209. In this embodiment, an example of file sharing will be described. For convenience of the description, it is assumed that the first application 208 is a file share source application and the second application 209 is a file share destination application. In the multi-window mode, the OS 207 divides the display area in the display unit 103 into a first display area 301 and a second display area 302. The OS 207 displays the screens of the first application 208 and the second application 209 in the divided display areas (display windows), respectively. Hereinafter, the method of displaying the applications will be referred to as multi-window display. On the other hand, in contrast to the multi-window mode, a state where one application is displayed in the entire area of the display unit 103 will be referred to as a single window mode. FIG. 3 shows examples showing the multi-window display in a state where the information processing apparatus 100 is vertically oriented and shows examples in which the screen is divided into two upper and lower screens. In a case where the information processing apparatus 100 is tilted in a horizontally oriented state, the multi-window display is performed in a form that the screen is divided into two left and right screens.

The multi-window mode is activated by a predetermined operation (hereinafter referred to as a multi-window mode activation operation) defined by the OS 207. In the present embodiment, the multi-window mode is activated by the history button 106 being touched and held while one application is displayed on the display unit 103 in the single window mode.

FIG. 3B shows an example of a screen at the time of activating the multi-window mode. FIGS. 3A and 3B will be used to describe an example of a general operation to display the screens of the first application 208 and the second application 209 in the multi-window mode from a state where the first application 208 is displayed in the single window mode. In a case where the user touches and holds the history button 106 in a state where the first application 208 is displayed on the display unit 103, the mode of the OS 207 shifts from the single window mode to the multi-window mode. Specifically, as shown in FIG. 3B, the OS 207 displays the first application 208 which has been displayed in the single window mode in the first display area 301, and displays an application list screen in the second display area 302.

Then, the user selects the second application 209 intended to be displayed in the second display area 302 from the application list screen. In a case where the second application 209 is selected, the OS 207 displays a top screen 304 of the second application 209 in the second display area 302, as shown in FIG. 3A. The top screen 304 shown in FIG. 3A is a screen in which main function buttons for the second application 209 which are displayed in a case where the second application 209 is activated are arranged.

In the present embodiment, touch-and-hold of the history button is given as an example of the multi-window mode activation operation, but the present disclosure is not limited to this. For example, the operation may be touch-and-hold of an application in the history of recently used applications displayed by tapping the history button, or an operation of selecting a plurality of applications intended to be displayed in a multi-window from the application list screen.

In the multi-window display state shown in FIG. 3A, an operation right is given only to either the first application 208 or the second application 209. The state where this operation right is given is referred to as active. In the case of a device with a touch panel, the operation right is transferred by a touch. For example, in a case where the first display area 301 receives some sort of user input such as a touch, the first application 208 becomes active. In a case where the second display area 302 receives some sort of user input such as touch, the second application 209 becomes active. That is, it is impossible for the first application 208 and the second application 209 to accept a screen operation at the same time.

An area division bar 303 is a User Interface (UI) part that separates the first display area 301 and the second display area 302. The initial position of the area division bar 303 in the multi-window mode is the center of the screen. The area division bar 303 can be moved by a user's drag or swipe operation as required. For example, the first display area 301 can be made larger than the second display area 302 by dragging the area division bar 303 downward. That is, dragging the area division bar 303 downward can change the sizes of the first display area 301 and the second display area 302 at the same time.

In the multi-window mode, data such as a file or text can be shared between applications by an operation such as drag-and-drop or copy-and-paste between windows. For example, the user drags an image displayed by the first application 208 displayed in the first display area 301 into the second display area 302 and drops the image onto the screen of the second application 209 displayed in the second display area 302. This drag-and-drop operation can copy image data corresponding to the image and held by the first application 208 to the second application 209 for sharing. Additionally, there is also a method in which the user copies the image data displayed by the first application 208 displayed in the first display area 301 to the clipboard and then performs a paste operation on the screen of the second application 209 displayed in the second display area 302 to copy and share the image data held by the first application 208 to the second application 209. Both methods are functions provided in the OS 207 as an accompaniment to the function of the multi-window mode.

In the present embodiment, a photograph app is used as the first application 208. The photograph app is an application in which an image stored in the storage device 206 of the information processing apparatus 100 can be viewed, edited, or the like. It is assumed that image formats handled by the first application 208 are, for example, JPEG, PNG, and GIF. However, image formats are not limited to them, and any image format such as BMP or TIFF may be handled. It is also assumed that the first application 208 corresponds to the function of sharing an image with an application displayed in the other display area by drag-and-drop at the time of being activated in the multi-window mode. In addition, the first application 208 has the function of copying an image displayed on the display unit to a clipboard. The user can paste the image copied to the clipboard to any application. The above drag-and-drop and image sharing with the clipboard are implemented by using the functions provided by the OS 207. For example, in a case where the user performs a copy operation of an image to the clipboard, the OS 207 stores, in the clipboard, the URI (Uniform Resource Identifier) in which the image is saved in the storage device 206. After that, in a case where the user performs the paste operation, the OS 207 passes the URI saved in the clipboard to the application in which the paste operation has been performed. The application that has received the URI obtains the image from the storage device 206 using the received URI. This makes it possible to share the image between the applications. Here, the example in which the storage destination indicated by the URI is the address of the storage device 206 has been described. However, in a case where an external URI of the information processing apparatus 100 is indicated, the image is obtained from an external device.

In the present embodiment, the print application is shown as an example of the second application 209. The print app is an application for connecting to an external device such as a printer or a multifunction device and printing a photograph or a document file saved in the information processing apparatus 100. The second application 209 is not limited to the print app and it is only required that the second application 209 have the function of receiving an image file, a document file, or the like from the other application. Specifically, it is only required that the second application 209 be capable of receiving any file by a drag-and-drop or paste operation in the multi-window mode. In the present embodiment, it is assumed that a file that can be handled by the second application 209 as the print application is JPEG, PNG, or PDF. However, the present disclosure is not limited to this, and file formats such as TIFF or Microsoft (registered trademark) Word, Excel, and the like may be handled.

In a display device with a small screen such as a smartphone, as in the information processing apparatus 100 of the present embodiment, the size of a window divided by using the multi-window mode is smaller than a window size in the case of a single window. Therefore, there is a case where the operability of the application in the multi-window mode is deteriorated. In the first place, in the multi-window mode, there is a case where the user is not aware that a file can be shared between applications in a case where no proper explanation is given. Then, in the present embodiment, a description will be given of an example of display control under which the user can easily perceive that a file can be shared between applications in the multi-window mode and easily performs sharing.

### File Sharing

Next, an example of file sharing in the present embodiment will be described. In the present embodiment, in the multi-window mode, the second application 209 receives an image file for printing from the first application 208. Then, a description will be given of an example in which the second application 209 displays a screen for printing the image file in the second display area 302.

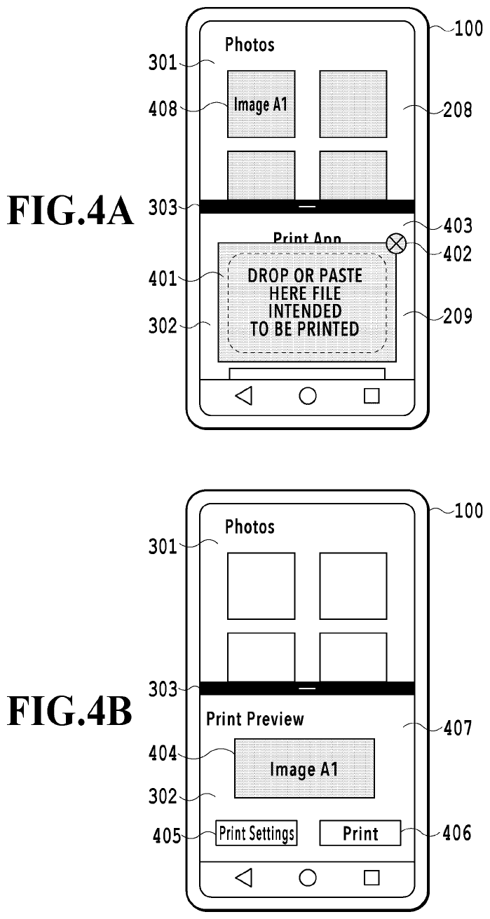

FIGS. 4A and 4B are diagrams showing an example of a screen in a case where two applications are displayed in the display unit 103 in the multi-window mode from a state where the first application 208 is displayed in the single window mode in the present embodiment. That is, FIGS. 4A and 4B are diagrams showing an example of a screen in a case where the first application 208 and the second application 209 are displayed in the multi-window mode. The second application 209 displays a file acceptance area 401 in the second display area 302 in a case where the multi-window mode is detected. The file acceptance area 401 is an area configured to be able to receive a shared file and is an area in which a message saying that the user is allowed to drop or paste the file is displayed. The user can immediately perceive that the file can be dropped or pasted in the file acceptance area 401 by checking the file acceptance area 401. FIG. 4A shows an example of a screen in which the file acceptance area 401 is displayed in the second display area 302. In the example in FIG. 4A, the file acceptance area 401 is floatingly displayed so as to cover the second display area 302 in which the second application 209 is displayed. In FIG. 4A, it is assumed that the file acceptance area 401 is floatingly displayed on the first screen in a case where the first screen is displayed in the second application 209. Incidentally, the file acceptance area 401 may be displayed by switching to the second screen including the file acceptance area 401 when the first screen is displayed in the second application 209.

In a case where a file “Image A1” 408 to be printed is delivered to the file acceptance area 401 by the user, the second application 209 displays a screen for printing the delivered file “Image A1” in the second display area 302. FIG. 4B shows an example in which the second application 209 displays a screen for printing the delivered file “Image A1” in the second display area 302. In FIG. 4B, a print preview screen of the delivered file “Image A1” is displayed. That is, in FIG. 4B, the process of displaying a print preview screen is performed as a predetermined process for the file delivered to the file acceptance area 401.

As described above, in the present embodiment, the screen displayed by the second application 209 undergoes the following screen transition for example. That is, the screen transitions from the top screen 304, which is any screen shown in FIG. 3A, through the acceptance screen 403 including the file acceptance area 401 shown in FIG. 4A, to a print preview screen 407 shown in FIG. 4B. The print preview screen 407 is a screen for printing the file received in the file acceptance area 401. For example, on the print preview screen 407, a print preview image 404 of the file to be printed, a print setting button 405 for performing print settings such as a paper size or the number of copies, and a print execution button 406 for executing printing are displayed. In a case where the print execution button 406 is operated, the information processing apparatus 100 transmits a print job for printing contents displayed in the print preview image 404 to a printer using the second application 209. The print job includes print settings set via the print setting button 405. Incidentally, the contents displayed in the print preview image 404 are the file (data) delivered from the first application 208. As a result, the contents displayed in the print preview image 404 are printed by the printer. Incidentally, the example in which the acceptance screen 403 shown in FIG. 4A is displayed after displaying the top screen 304 has been shown here. However, in a case where the second application 209 is activated in the multi-window mode, the acceptance screen 403 may be displayed without displaying the top screen 304.

The size of the file acceptance area 401 on the acceptance screen 403 in FIG. 4A can be changed depending on the size of the second display area 302. Specifically, in a case where the second application 209 receives the size change of the second display area 302 from the OS 207, the size of the second display area 302 can be changed in accordance with received window size information. The size of the file acceptance area 401 changes depending on the size of the second display area 302. The window size information includes the height and width of the second display area 302. As a result, even in a case where the size of the second display area 302 is changed by operating the area division bar 303, the file acceptance area 401 of an appropriate size can be displayed.

The file acceptance area 401 includes a non-display button 402. In a case where the non-display button 402 is pressed (touched) by the user, the second application 209 hides the file acceptance area 401. As a result, the second application 209 can display the same screen as in the case of being activated in the single window mode. For example, since the file acceptance area 401 is floatingly displayed on any screen of the second application 209, in a case where the file acceptance area 401 is hidden, any screen is displayed. In the present embodiment, the example in which the file acceptance area 401 is floatingly displayed is shown, but the present disclosure is not limited to this example. That is, by pressing the non-display button 402, the second application may close the entire screen displayed in the second display area 302 and display another new screen.

In the present embodiment, the example is shown in which in a case where the non-display button 402 is pressed by the user, the second application 209 hides the file acceptance area 401, but the present disclosure is not limited to this. For example, in a case where the non-display button 402 is pressed by the user, the second application 209 not only hides the file acceptance area 401 but also may display a redisplay button (not shown) in the second display area 302. Alternatively, as another example, in a case where the second application 209 detects the user's drag operation or paste operation in the second display area 302 after the file acceptance area 401 is hidden, the file acceptance area 401 may also be displayed again. As a result, even in a case where the file acceptance area 401 is hidden, the file acceptance area 401 can be displayed again on any screen displayed by the second application 209. As shown in FIG. 4A, the file acceptance area 401 includes a message display for indicating an operation method for the user. This makes it possible to apply a file sharing function to the user and show a file sharing method. In the present embodiment, the example of displaying a message in the file acceptance area 401 has been shown, but the present disclosure is not limited to this, and a representation using an icon or a sign may be used.

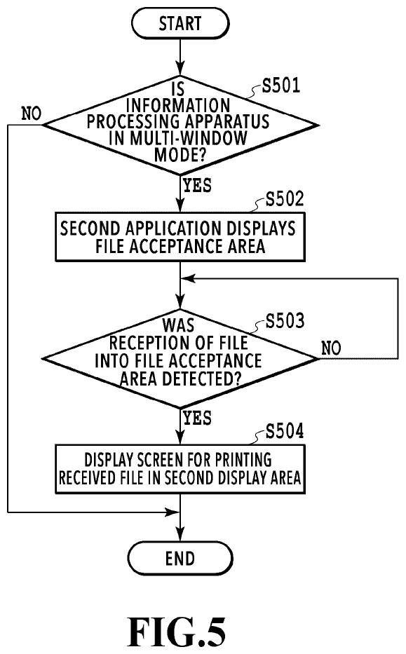

FIG. 5 is a flowchart showing an example of a process in the second application 209 of the present embodiment. FIG. 5 shows an example in which the second application 209 detects the multi-window mode, displays the file acceptance area 401 shown in FIG. 4, and performs a predetermined process using the file delivered to the file acceptance area 401. In the present embodiment, the second application 209 is a print application, and the predetermined process is a process at the time of displaying a screen for printing the file delivered to the file acceptance area 401 in the second display area. The process shown in FIG. 5 is implemented by the CPU 201 expanding a program stored in the storage device 206 or the like into the memory 204 and executing the program. A symbol “S” in the description of each process means a step in the flowchart (the same applies in the present specification).

The flowchart in FIG. 5 is started in a case where the second application 209 is activated and is displayed in the second display area 302 by tapping the icon 105 in the multi-window mode or the like. Additionally, the flowchart in FIG. 5 is a process which is permanently performed. That is, during activation of the second application 209, the process shown in FIG. 5 is periodically (substantially always) performed. In other words, even in a case where the second application 209 displays any screen, the file acceptance area 401 is displayed in a case where the multi-window mode is detected.

In S501, the second application 209 determines whether the information processing apparatus 100 is in the multi-window mode. Specifically, the second application 209 makes an inquiry to the OS 207 as to whether the information processing apparatus 100 is in the multi-window mode. Then, whether the information processing apparatus 100 is in the multi-window mode is determined based on information obtained in response to the inquiry. In a case where the information processing apparatus 100 is in the multi-window mode, the process proceeds to S502, and if not, the process ends. As described above, there is a case where the second application 209 is activated after the information processing apparatus 100 transitions to the multi-window mode with the first application 208 being activated. Alternatively, there is also a case where the information processing apparatus 100 transitions to the multi-window mode in a state where the second application 209 is activated in the single window mode. In the former case, the determination in S501 can also be said to be a process of determining whether the second application 209 is activated in the multi-window mode. In the latter case, the determination in S501 can also be said to be a process of determining whether the information processing apparatus in which the second application 209 is activated has transitioned from the single window mode to the multi-window mode. In the present embodiment, the former example, that is, an example in which the second application 209 is activated after the information processing apparatus 100 transitions to the multi-window mode with the first application 208 being activated will be described. The latter example will be described later.

In S502, the second application 209 displays the file acceptance area 401 in the second display area 302. That is, the second application 209 displays the file acceptance area 401 in the second display area 302 designated as its own display area by the OS. This makes it possible for the second application 209 to be in the state of accepting file sharing while indicating to the user that the file sharing from the other application is accepted in a case where the second application 209 detects the multi-window mode. For example, in a case where the second application 209 is activated in the multi-window mode, it is possible to be in a state of accepting file sharing while indicating to the user that file sharing from the other application is accepted. As described above, the file acceptance area 401 is an area capable of receiving a drag-and-drop or paste operation of a file from the other application.

Next, in S503, the second application 209 determines whether the reception of the file in the file acceptance area 401 is detected. Specifically, the second application 209 determines whether content information on the file delivered to the file acceptance area 401 has been received from the OS 207. In the present embodiment, it is assumed that the JPEG image file “Image A1” displayed in the first application 208 is dragged and dropped into the file acceptance area 401. The content information includes a URI indicating a location where the file delivered to the file acceptance area 401 is stored. The second application 209 can obtain the file “Image A1” delivered to the file acceptance area 401 by accessing the URI included in the received content information. In a case where it is determined in S503 that the file has been received in the file acceptance area 401, the second application 209 executes a step S504. On the other hand, in a case where the file is not received in the file acceptance area 401, the step S503 is executed again to wait for the reception of the file in the file acceptance area 401.

In S504, the second application 209 executes a predetermined process using the received file. For example, the second application 209 displays a screen (print preview screen 407) for printing the received file “Image A1” in the second display area 302. Specifically, the second application 209 obtains the file “Image A1” from the storage device 206 using the URI included in the content information received in S503 and displays the file as the print preview image 404 of the print preview screen 407. This makes it possible to display a screen for print setting or print execution for the file received from the first application 208, which is the other application, in response to reception of the file in the file acceptance area 401.

In a case where it is determined in S501 that the information processing apparatus 100 is not in the multi-window mode, the second application 209 does not accept file sharing in the multi-window mode. Therefore, the process ends without performing the step S502 and subsequent steps. This makes it possible to display the file acceptance area 401 only in a case where the information processing apparatus 100 is in the multi-window mode. The flowchart in FIG. 5 ends in a case where the second application 209 is hidden in the second display area 302. An example is a case where the home button 101 is tapped by the user while the second application 209 has an operation right. This makes it possible to suppress a possibility that an unnecessary process is performed in a case where the screen of the second application 209 is not displayed. Alternatively, the flowchart in FIG. 5 may end in a case where the multi-window mode is ended by the user's operation. As a result, the file acceptance area 401 can be hidden without the need for a user operation at the time of release of the multi-window mode. Further, the file acceptance area 401 can also be hidden in a case where the multi-window mode is released by the first application 208 being ended.

As described above, in the present embodiment, the file acceptance area 401 is displayed in S502 in FIG. 5 in response to displaying the second application 209 in the multi-window mode. This makes it possible to show the user how to share the file to the second application 209 and to provide the function of sharing the file. This can produce the effect of simple file sharing between applications in the multi-window mode.

Although the example of the case where the second application 209 displays a screen in the second display area 302 has been described so far, the flowchart shown in FIG. 5 is not necessarily limited to a case where the second application 209 displays the screen in the second display area 302. As described above, the flowchart shown in FIG. 5 may be executed in a state where the second application has been activated first in the single window mode. That is, the process in the flowchart shown in FIG. 5 can be applied even in a case where the second application 209 displays the screen in the first display area 301 and the first application 208 displays the screen in the second display area 302. That is, the flowchart in FIG. 5 can be applied even in a case where the first application 208 is activated in the multi-window mode and is displayed in the second display area 302 from a state where the second application 209 displays the screen in the single window mode. In this case, the flowchart in FIG. 5 may be started after the second application 209 is activated or may be started in a case where the operation right is first assigned to the second application 209 displayed in the first display area 301 after the start of the multi-window mode.

That is, in a state where the second application 209 is activated in the single window mode, as shown in FIG. 3B, the area division bar 303 is displayed and the mode of the information processing apparatus 100 shifts to the multi-window mode. As described above, at the time when the mode of the information processing apparatus 100 shifts to the multi-window mode, a file acceptance area may be displayed in the first display area 301. Alternatively, the file acceptance area may be displayed in the first display area 301 at the time when the other application is activated in the second display area 302 after the mode of the information processing apparatus 100 shifts to the multi-window mode. Alternatively, in a case where the operation right is first assigned to the second application 209 displayed in the first display area 301 after the other application is activated in the second display area 302, the file acceptance area may be displayed in the first display area 301.

As described above, the second application 209 displaying the file acceptance area can display the file acceptance area regardless of the location of a window (display area) displayed in the multi-window mode. In the present embodiment, the example in which the display unit 103 is divided into two as the multi-window mode has been shown, but the present disclosure is not limited to this. It is also possible to apply the present embodiment to an information processing apparatus with a multi-window mode having three or more windows (display areas) in the display unit 103. Further, in the present embodiment, the smartphone with a touch panel has been used as an example of an information processing apparatus, but the present disclosure is not limited to this and can be applied to a PC operated with a keyboard or a mouse.

In the example described above, an example of delivering the image file to the file acceptance area has been described. However, the file to be shared is not limited to an image file. In the above example, in S504 in FIG. 5, the second application 209 displays the print preview screen 407 of the image file. However, the print preview screen 407 may display a screen different from the print preview screen 407 in accordance with the format of the received file. For example, in a case where a document file such as a PDF document file is received instead of an image file, a preview screen of the document file may be displayed. That is, a screen depending on the type of a file may be displayed.

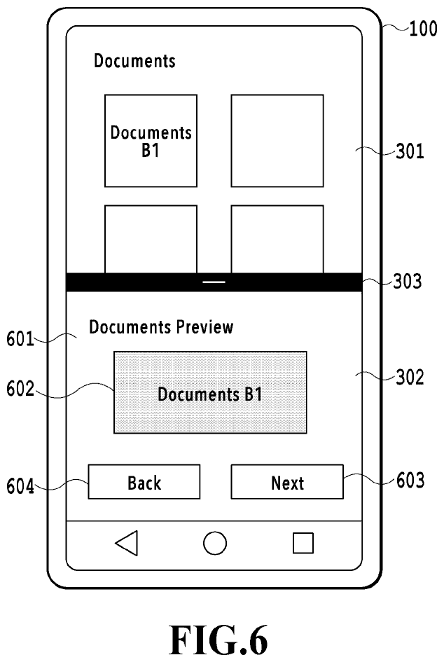

FIG. 6 is a diagram showing an example of a document preview screen 601 to be displayed in a case where the second application 209 receives a document file B1 in a PDF format. The document preview screen 601 includes a document preview image 602, a next button 603, and a back button 604. FIG. 6 shows a diagram of a state after the file is already delivered. However, as illustrated in FIGS. 4A and 4B, the area where the document preview image 602 is displayed functions as the file acceptance area before the file is delivered.

The document preview image 602 is an area for displaying the contents of the document file B1 received by the second application 209. Specifically, the second application 209 obtains a PDF file from the OS 207 using the URI included in the received content information. The second application 209 renders the obtained PDF file and displays the file as the document preview image 602. The next button 603 is a button for printing the document file B1. In a case where the user taps the next button 603, the second application 209 displays a screen for printing the document file B1 in the second display area 302. Therefore, the second application 209 displays a screen in accordance with the received file format, so that the user does not need to perform an operation in consideration of the format of the file, and usability can be increased.

In the print preview screen 407 in FIG. 4B or the document preview screen 601 in FIG. 6, the process is completed in a case where the second application is instructed to perform various subsequent operations. For example, a printing process is completed. In a case where the process is completed as described above, in a case where the multi-window mode is not released, the file acceptance area is displayed again on the screen of the second application 209.

As described above, according to the present embodiment, the user can easily perceive that the file can be shared between the applications in the multi-window mode, and can easily execute sharing.

### Second Embodiment

In the first embodiment, the example in which the second application 209 receives an image file in a JPEG format from the first application 208 has been described. There is a case where the second application 209 receives a file which cannot be handled by the second application 209 from the other application. For example, there is a case where a file in a file format other than a file format which can be handled by the second application 209 is delivered. There is also a case where a file having a size larger than a file size which can be handled by the second application 209 is delivered. In such cases, the second application cannot perform predetermined processing of the received file. Then, in the present embodiment, an example will be described of showing appropriate guidance to the user even in a case where a file which cannot be handled by the second application 209 is delivered. Since a basic configuration is the same as that of the example described in the first embodiment, the description thereof will be omitted.

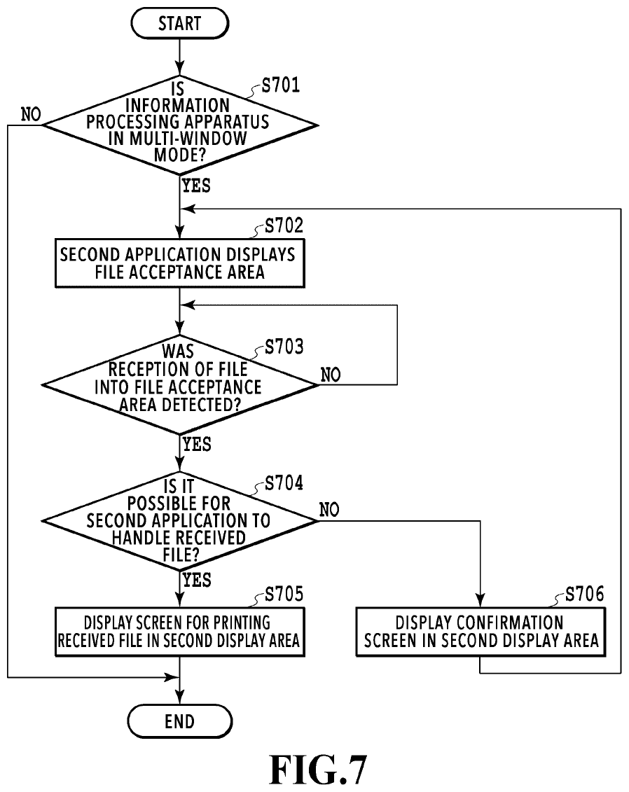

FIG. 7 is a flowchart showing an example of a process executed in the second application 209 in the present embodiment. The flowchart shown in FIG. 7 is started under the same start conditions as those for the flowchart shown in FIG. 5 of the first embodiment. Further, since steps S701 to S703 are the same as the steps S501 to S503 in FIG. 5, the description thereof will be omitted.

In the case of detecting the reception of a file into the file acceptance area in S703, the a step S704 is performed. In S704, the second application 209 determines whether the received file can be handled by the second application. Specifically, the second application 209 determines whether an extension of the file obtained in S703 corresponds to an extension in corresponding extension information held by the second application 209 in advance. The corresponding extension information specifically includes a character string such as JPEG, PNG, or PDF. This determination makes it possible to determine whether the received file is in a file format which can be handled by the second application 209. In the present embodiment, the extension is used to determine whether the file can be handled by the second application 209, but the present disclosure is not limited to this, and the determination may be made using information on a file size or resolution. In a case where it is determined in S704 that the file received by the second application 209 is a file which can be handled by the second application, S705 is executed. Since S705 is the same as the step S504 in FIG. 5, the description thereof will be omitted.

On the other hand, in a case where it is determined in S704 that the file received by the second application 209 cannot be handled by the second application, S706 is executed. The fact that the file received by the second application 209 cannot be handled by the second application means that the reception of the file is canceled. In S706, the second application 209 displays a predetermined confirmation screen in the second display area 302.

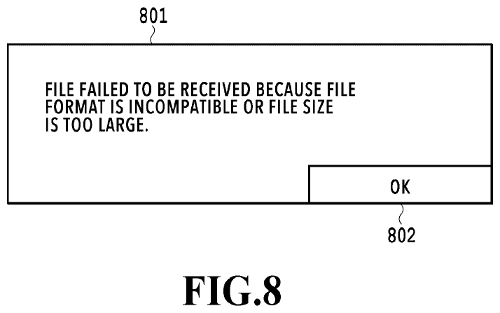

FIG. 8 is a diagram showing an example of a confirmation screen 801 displayed by the second application 209 in S706. The confirmation screen 801 includes a message informing the user that the file intended to be shared to the second application 209 cannot be shared. In FIG. 8, a message is included saying that the file intended to be shared to the second application 209 is in a file format or a file size which cannot be handled by the second application 209. This allows the user to recognize the fact and the reason that the file could not be shared.

The confirmation screen 801 includes a confirmation button 802. In a case where the confirmation button 802 is pressed (touched) by the user, the second application 209 closes the confirmation screen 801 and executes the step S702 again. In S702, the second application 209 displays the file acceptance area 401 in the second display area 302 again. As a result, the second application 209 enters a state of receiving the file again without the need for the user's operation, so that the user's convenience is increased.

As described above, in the present embodiment, whether the file received by the second application 209 can be handled is determined in S704 in FIG. 7, and the fact and reason that the file sharing is canceled are displayed in S706. This makes it possible to notify the user of the failure of the file sharing at the timing of the file sharing. In addition, executing S702 after S706 can eliminate the need for a user operation for displaying the file acceptance area again and can provide appropriate guidance to the user.

The confirmation screen 801 is merely an example and may be in a form of displaying a message different depending on a reason. For example, being in a file format or file size which cannot be handled by the second application 209 may be specified and informed. Further, a solution may be displayed on the confirmation screen 801. For example, in a case where a file size is too large, a confirmation screen including a message to the effect that the file size is too large and a message indicating a file size allowed by the second application 209 may be displayed.

### Third Embodiment

In the second embodiment, the example has been described of the case of receiving a file which cannot be handled by the second application 209. In a case where a file is received, there is a case where processing cannot be performed of the received file depending on the state of the second application 209. For example, while the second application 209, which is the print application, is executing other processes such as the printing process or scanning process, there is a case where a screen for printing the received file cannot be displayed. In this case, the second application 209 cannot perform a predetermined process using the received file in the file acceptance area. Then, in the present embodiment, an example will be described of showing appropriate guidance to the user in a state where the second application 209 cannot perform processing of the file received by the second application 209. Since a basic configuration of the present embodiment is the same as that of the example described in the first embodiment, the description thereof will be omitted.

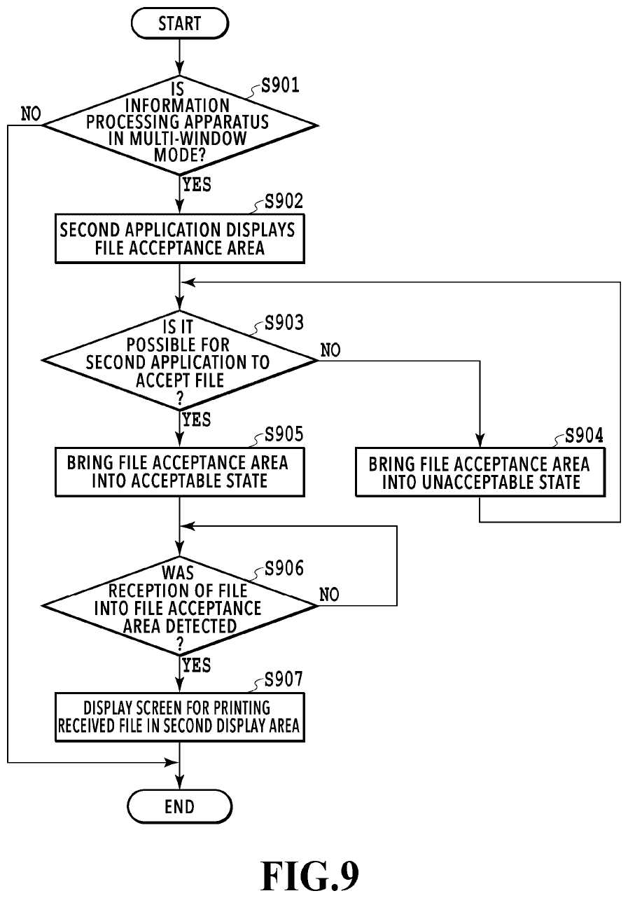

FIG. 9 is a diagram showing an example of a flowchart executed by the second application 209 in the present embodiment. The flowchart shown in FIG. 9 is started under the same start conditions as those for the flowchart shown in FIG. 5 of the first embodiment. Further, since steps S901 to S902 are the same as the steps S501 to S502 in FIG. 5, the description thereof will be omitted.

After displaying the file acceptance area in S902, the second application 209 determines in S903 whether the file can be accepted. Specifically, the second application 209 determines whether a specific process is being executed. The specific process is a process that cannot be performed in parallel with a predetermined process (e.g., a display process of the print preview screen) using the file received in the file acceptance area 401. Examples of the specific process include, for example, a printing process or scanning process of a different image. In a case where these processes are being executed, it is determined that the specific process is being executed. In a case where it is determined in S903 that the second application 209 cannot accept the file, the second application 209 executes S904. In S904, the second application 209 brings the file acceptance area 401 into an unacceptable state.

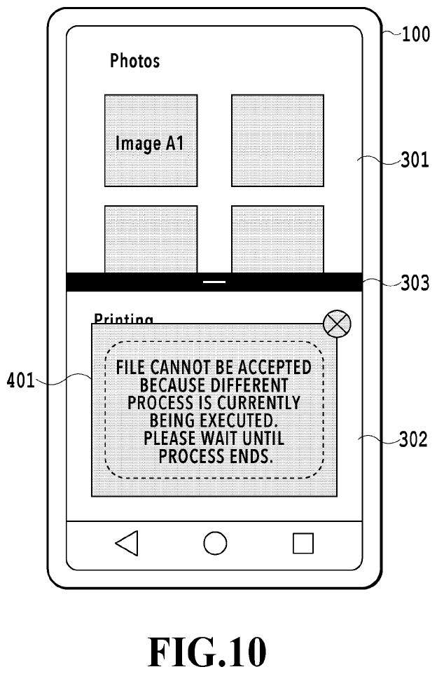

FIG. 10 is a diagram showing an example of a screen showing unacceptable information. FIG. 10 shows an example of a case where the second application 209 displays the file acceptance area 401 in the unacceptable state during the execution of the printing process. The file acceptance area 401 in the unacceptable state does not accept the reception of a file from the other application. Specifically, the area does not accept the paste or drag-and-drop of the file. The state of the file acceptance area 401 that can accept the reception of the file is called an acceptable state in contrast with the unacceptable state. In the file acceptance area 401 in the unacceptable state, a message saying that the file cannot be accepted is displayed in the file acceptance area 401. This allows the user to know that the file cannot be shared with the second application 209 before performing a file sharing operation.

In the present embodiment, whether the file can be received is shown by changing messages displayed in the file acceptance area 401, but the present disclosure is not limited to this, and the display mode may be a display mode in which the file acceptance area 401 is grayed out. In S904 in FIG. 9, the second application 209 brings the file acceptance area 401 into the unacceptable state and then executes S903 again. In a case where it is determined in S903 that the second application 209 can accept the file, the second application 209 executes S905. In S905, the second application 209 brings the file acceptance area into the acceptable state. In this way, in a case where the second application 209 enters a state where the file can be received, the file acceptance area can be in the acceptable state. Subsequent processing steps from S906 to S907 are the same as the processing steps from S503 to S504 in FIG. 5, and thus the description thereof will be omitted.

As described above, in the present embodiment, in S903 in FIG. 9, whether the second application 209 can receive the file is determined, and the display of the file acceptance area 401 is switched depending on the determination result. As a result, it is possible to notify, before the file sharing operation, the user that the second application 209 cannot receive the file, and convenience at the time of file sharing can be increased.

As described above, in the present embodiment, in the case of the multi-window mode, a second screen different from the first screen is displayed in a state where a predetermined process cannot be performed or is not allowed to be performed. A predetermined message may be displayed on the second screen. In a case where a specific process which is a factor that prevents the predetermined process from being performed is completed while the second screen is being displayed, the screen transitions from the second screen to the first screen without accepting a user operation.

In the present embodiment, the specific process (e.g., the printing process or the scanning process) and the predetermined process (e.g., the display process of the print preview screen) are described as separate processes, but the specific process may be a process of the same type as that of the predetermined process. For example, in a case where file sharing is performed in the file acceptance area 401, it is assumed that the printing process is performed immediately. In this case, in a case where the printing process for a different file has already been executed, the second application 209 has already been executing specific processing (printing process) of the first file, so that the second application 209 cannot perform predetermined processing (printing process) of the other second file. Thus, the file acceptance area 401 is brought into the unacceptable state. Therefore, the specific process and the predetermined process may be the same type of process.

### Other Embodiments

The embodiments described above can be applied in combination as appropriate. For example, the second embodiment and the third embodiment may be combined. For example, the steps S903 to S905 in FIG. 9 may be introduced between S702 and S703 in FIG. 7.

In the embodiments described above, the example has been described in which the second application 209 displays the file acceptance area 401 in a case where being in the multi-window mode is determined. Then, the example has been described in which in a case where a file is delivered to the file acceptance area 401, the predetermined process using the file is executed. Here, it is assumed that the file is delivered into the display area (into the second display area 302 herein) including the file acceptance area 401 and displayed by the second application 209. For example, it is assumed that in a case where a drag-and-drop operation is performed, the file is dropped in the display area of the second application 209 at a position outside the file acceptance area 401. In this case, the second application 209 may perform control so as not to accept the dropped file, or may perform control so as to accept the dropped file. In a case where the file is not accepted, the control is performed so that behavior as it looks is emphasized. In the case of accepting the file, the file acceptance area 401 is positioned as a mere marker, and it is only required that the second application perform processing of the file dropped in the second display area 302 as described in the embodiments described above. In the case of the process of accepting a file, the acceptance area becomes larger, so that usability can be increased.

In the embodiments described above, the example has been described in which the predetermined process executed in a case where the second application 209 receives the file is a process for executing a printing function (specifically, the display process of the print preview screen). However, the present disclosure is not limited to this. The predetermined process may be display of a setting screen for performing image processing of the file. For example, examples of the image processing may include, in addition to the execution of the printing function, a process for executing a scan function or an image editing function. The embodiments described above are not limited to a smartphone but can be applied to, for example, a tablet terminal or a PC terminal. The embodiments described above can be applied only to an information processing apparatus with a multi-window mode having the function of allowing the second application 209 to receive a file from the other application.

Further, in the embodiments described above, the example has been described in which a sharing target is data in a file format, but the present disclosure is not limited to this. The sharing target may be data in a text format. For example, a text displayed in the first application 208 may be selected to drag and drop a selected portion into a text acceptance area of the second application 209. For example, in the case of an application such that the second application 209 receives a predetermined command and executes a predetermined process, the predetermined command may be dragged-and-dropped and delivered from the first application 208. As described above, the sharing target may be an object in any form. For example, the sharing target may be an object of data in the text format, an object of data in the file format, or an object in any other form. That is, the file acceptance area described in the embodiments described above can be applied as an object acceptance area.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-177389, filed Oct. 29, 2021, which is hereby incorporated by reference wherein in its entirety.

1.-16. (canceled)

17. An information processing apparatus that executes a first application and a second application different from the first application, the information processing apparatus comprising:
a controller that controls the information processing apparatus to
activate the second application either (i) in a single window mode, wherein after the second application is activated in the single window mode the first application is activated in a multi-window mode, or (ii) in the multi-window mode, wherein before the second application is activated the first application is activated in the single window mode;
in a case where the information processing apparatus is in the multi-window mode, newly display, on an object acceptance area in a display window of the second application, a message which indicates that the object acceptance area is available for sharing an object displayed in a display window of the first application to the second application;
in a case where the information processing apparatus is in the single window mode, control such that the message is not displayed;
detect a sharing operation of dragging and dropping the object displayed in the display window of the first application to the object acceptance area displayed in the display window of the second application; and
in response to detecting the sharing operation of dragging and dropping the object displayed in the display window of the first application to the object acceptance area displayed in the display window of the second application, execute a predetermined process using the object.

18. The information processing apparatus according to claim 17, wherein the predetermined process is a process of displaying a setting screen for performing image processing of the object.

19. The information processing apparatus according to claim 17, wherein the predetermined process is a process of displaying a preview screen for printing.

20. The information processing apparatus according to claim 17, wherein in the executing, a preview screen is displayed which varies depending on a type of the accepted object.

21. The information processing apparatus according to claim 17, wherein in a state where the message is displayed in the displaying, a part for hiding the message is further displayed in a display window of the second application.

22. The information processing apparatus according to claim 17, wherein the second application detects whether the information processing apparatus is in the multi-window mode based on information from an operating system operating in the information processing apparatus.

23. The information processing apparatus according to claim 17, wherein the message is floatingly displayed on the display window of the second application.

24. The information processing apparatus according to claim 17, wherein the controller that controls the information processing apparatus to:
detect that a sharing operation of an object which cannot be handled by the second application is performed in the object acceptance area, and
in response to detecting a sharing operation of the object which cannot be handled by the second application, display a confirmation screen to cancel sharing of the object.

25. The information processing apparatus according to claim 17, wherein the controller that controls the information processing apparatus to:
determine that the second application cannot accept sharing of the object, and
in response to determining that the second application cannot accept sharing of the object, control a display mode of the message to be different from a display mode in a state where the sharing of the object can be accepted.

26. The information processing apparatus according to claim 25, wherein the controller that controls the information processing apparatus to:
detect that the second application is executing a specific process which cannot be executed in parallel with the predetermined process, and
in response to detecting that the second application is executing the specific process which cannot be executed in parallel with the predetermined process, determine that the second application cannot accept the sharing of the object.

27. The information processing apparatus according to claim 17, wherein in the multi-window mode, between the display window of the second application and a display window of the first application, a bar for changing sizes of both display windows simultaneously is displayed.

28. The information processing apparatus according to claim 17, wherein
the second application detects the information processing apparatus is in the multi-window mode, and
the second application detects the information processing apparatus is in the single window mode.

29. The information processing apparatus according to claim 17, wherein the sharing operation includes a paste operation of the object to the object acceptance area.

30. The information processing apparatus according to claim 17, wherein, in the multi-window mode, the controller accepts the object in response to a drop of the object onto any position within the display window of the second application, including a position outside the object acceptance area.

31. The information processing apparatus according to claim 17, wherein the controller changes a size of the object acceptance area in accordance with a size change of the display window of the second application in the multi-window mode.

32. The information processing apparatus according to claim 21, wherein, after the message is hidden, the controller re-displays the message in response to detection of a drag operation or a paste operation in the display window of the second application.

33. The information processing apparatus according to claim 17, wherein the controller hides the message in response to detecting that the information processing apparatus exits the multi-window mode.

34. A non-transitory computer readable storage medium storing a program which causes a computer to execute a method of controlling an information processing apparatus that executes a first application and a second application different from the first application, the method comprising:
activating the second application either (i) in a single window mode, wherein after the second application is activated in the single window mode the first application is activated in a multi-window mode, or (ii) in the multi-window mode, wherein before the second application is activated the first application is activated in the single window mode;
in a case where the information processing apparatus is in the multi-window mode, newly displaying, on an object acceptance area in a display window of the second application, a message which indicates that the object acceptance area is available for sharing an object displayed in a display window of the first application to the second application;
in a case where the information processing apparatus is in the single window mode, controlling such that the message is not displayed;
detecting a sharing operation of dragging and dropping the object displayed in the display window of the first application to the object acceptance area displayed in the display window of the second application; and
in response to detecting the sharing operation of dragging and dropping the object displayed in the display window of the first application to the object acceptance area displayed in the display window of the second application, executing a predetermined process using the object.

35. A method of controlling an information processing apparatus that executes a first application and a second application different from the first application, the method comprising:
activating the second application either (i) in a single window mode, wherein after the second application is activated in the single window mode the first application is activated in a multi-window mode, or (ii) in the multi-window mode, wherein before the second application is activated the first application is activated in the single window mode;
in a case where the information processing apparatus is in the multi-window mode, newly displaying, on an object acceptance area in a display window of the second application, a message which indicates that the object acceptance area is available for sharing an object displayed in a display window of the first application to the second application;
in a case where the information processing apparatus is in the single window mode, controlling such that the message is not displayed;
detecting a sharing operation of dragging and dropping the object displayed in the display window of the first application to the object acceptance area displayed in the display window of the second application; and
in response to detecting the sharing operation of dragging and dropping the object displayed in the display window of the first application to the object acceptance area displayed in the display window of the second application, executing a predetermined process using the object.
